(19) United States
(12) Patent Application Publication
(10) Pub. No.: US 2013/0047798 A1
(43) Pub. Date: Feb. 28, 2013

(54) Ball End Hex Wrench

(71) Applicant: Ping-Wen Huang, Taichung City (TW)

(72) Inventor: Ping-Wen Huang, Taichung City (TW)

(21) Appl. No.: 13/216,334

(22) Filed: Aug. 24, 2011

(51) Int. Cl. B25B 23/00

(52) U.S. Cl. 81/461

(57) ABSTRACT

A ball end hex wrench includes a ball end including an engaging section, at least one first pattern, and at least one second pattern. The engaging section includes a plurality of peripheral surfaces disposed circumferentially. The at least one first pattern is defined on one of the plurality of peripheral surfaces. The at least one first pattern has a first longitudinal length and a first height. The at least one second pattern is defined on the one of the plurality of peripheral surfaces. The at least one second pattern has a second longitudinal length and a second height. The second height is different from the first height.

### BACKGROUND OF THE INVENTION

1. Field of the Invention

The present invention relates to a ball end hex wrench.

2. Description of the Related Art

TW Patent No. M284495 shows a ball end hex wrench. The hex wrench includes a ball end adapted for driving an object. Generally, the object has a hole defined therein for receiving the ball end. In this hex wrench, the ball end includes a recess defined therein. Further, a detent ball and a spring are disposed in the recess. The detent ball is moveable in the recess and positionable at a position that it includes a portion disposed outside an opening of the recess. Moreover, the detent ball has a spherical shape and is resiliently biased by the spring to abut against a periphery of the hole of the object. According to the patent, the resiliently biased detent ball allows the ball end to be engaged and disengaged from the hole of the object more easily, the hole of the object to be less likely to become damaged, and operating the hex wrench to drive the object more effortlessly. However, a problem that the detent ball and the spring suffer is that they are liable to be damaged when a relative large resistance force should be overcome in order to drive the object. Another problem is that installation of the detent ball and the spring are laborious. Additionally, it becomes easier for the hex wrench to turn relative to the object, so the object is not driven as the hex wrench is operably moved in this regard.

The present invention is, therefore, intended to obviate or at least alleviate the problems encountered in the prior art.

### SUMMARY OF THE INVENTION

According to the present invention, a ball end hex wrench includes a ball end capable of being used to drive an object. The ball end includes an engaging section, at least one first pattern, and at least one second pattern. The engaging section is abutted against the object when the ball end hex wrench drives the object. The engaging section includes a plurality of peripheral surfaces. The plurality of peripheral surfaces are disposed circumferentially. Each of the plurality of peripheral surfaces extends arcuately. The at least one first pattern is defined on one of the plurality of peripheral surfaces. The at least one first pattern has a first longitudinal length and a first height. The at least one second pattern is defined on the one of the plurality of peripheral surfaces. The at least one second pattern has a second longitudinal length and a second height. The second height is different from the first height. The hex wrench further includes an operating end, and a neck. The neck includes a first distal end connected with the ball end and a second distal end connected with the operating end respectively and extends arcuately from the first distal end to the second distal end.

It is an object of the present invention to allow the ball end to be engaged and disengaged from the object more easily.

It is another object of the present invention to prevent the ball end hex wrench from easily damaging a hole of the object.

It is a further object of the present invention to render operating the hex wrench to drive the object more effortlessly.

Other objects, advantages, and new features of the present invention will become apparent from the following detailed description of the invention when considered in conjunction with the accompanied drawings.

### BRIEF DESCRIPTION OF THE DRAWINGS

FIG. 1 is a perspective view of a ball end hex wrench in accordance with a first embodiment of the present invention.

FIG. 2 shows the hex wrench of FIG. 1 driving a first object and disposed at a first working-angle position, with the ball end engaged with the first object, with the ball end received in a hole defined in the first object.

FIG. 3 is a cross-sectional view of FIG. 2.

FIG. 4 is an extended cross-sectional view of FIG. 3 showing the hex wrench in the operation of driving the first object, with the ball end abutted against a periphery of the hole of the first object.

FIG. 5 is a perspective view of a ball end hex wrench in accordance with a second embodiment of the present invention.

FIG. 6 is a partial enlarged view of FIG. 5.

FIG. 7 is a partial, side view of the hex wrench of FIG. 5.

FIG. 8 is a top view of the hex wrench of FIG. 5.

FIG. 9 shows the hex wrench of FIG. 5 driving the first object and disposed at the first working-angle position, with the ball end engaged with the first object, with the ball end received in the hole of the first object.

FIG. 10 is a cross-sectional view of FIG. 5.

FIG. 11 is an extended cross-sectional view of FIG. 10 showing the hex wrench in the operation of driving the first object, with the ball end abutted against the periphery of the hole of the first object.

FIG. 12 shows the hex wrench of FIG. 5 in the operation of driving the first object and disposed at a second working-angle position.

FIG. 13 shows the hex wrench of FIG. 5 in the operation of the driving the first object and disposed at a third working-angle position.

FIG. 14 shows the hex wrench of FIG. 5 in the operation of the driving a second object and disposed at the first working-angle position.

FIG. 15 is a cross-sectional view of FIG. 14 showing the hex wrench in the operation of driving the second object, with the ball end received in a hole defined in the second object, with the ball end abutted against a periphery of the hole of the second object.

FIG. 16 is a perspective view of a ball end hex wrench in accordance with a third embodiment of the present invention.

FIG. 17 is a cross-sectional view of FIG. 16.

FIG. 18 is an extended cross-sectional view of FIG. 17 showing the hex wrench in the operation of driving the first object, with the ball end abutted against the periphery of the hole of the first object.

### DETAILED DESCRIPTION OF THE PREFERRED EMBODIMENTS

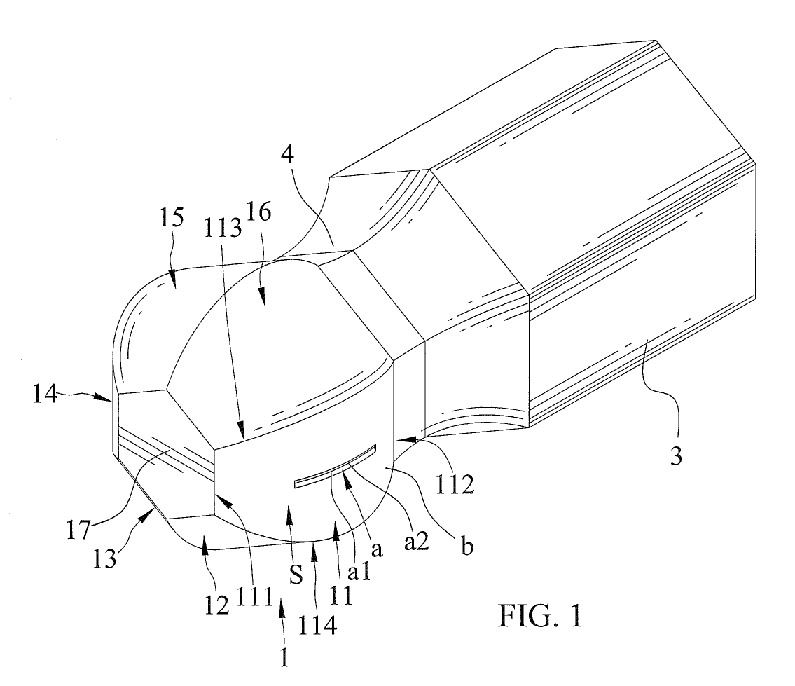

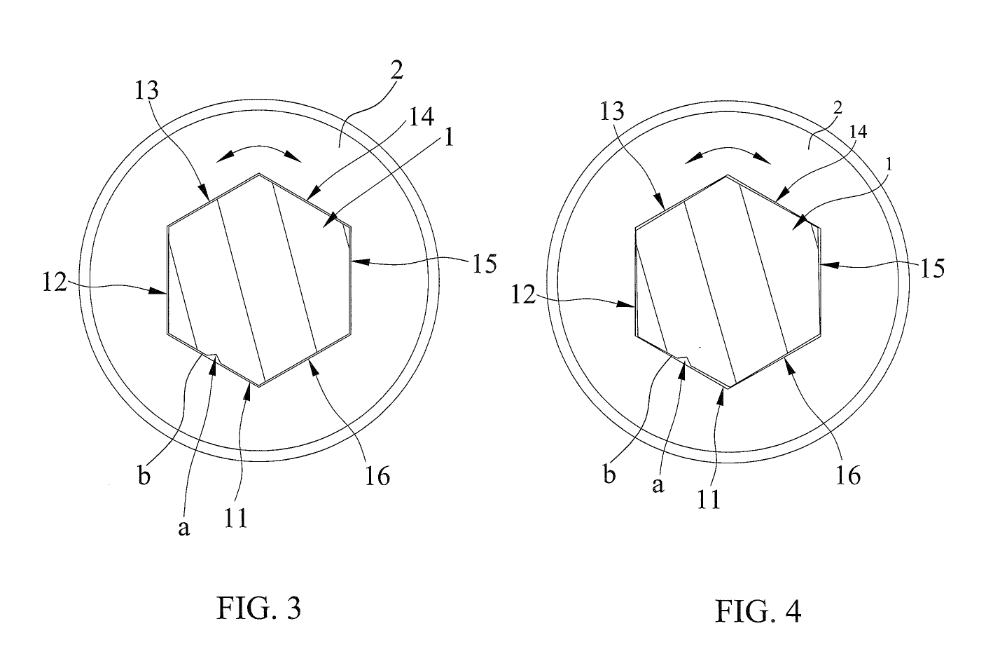

FIGS. 1 through 4 show a ball end hex wrench in accordance with a first embodiment of the present invention. The ball end hex wrench includes a ball end 1. The ball end 1 includes first and second ends 111 and 112, and first and second lateral sides 113 and 114 extending from the first end 111 to the second end 112. Moreover, the ball end 1 includes an engaging section S, at least one first pattern a, and at least one second pattern b. The engaging section S includes a plurality of peripheral surfaces, i.e., first, second, third, fourth, fifth, and sixth peripheral surfaces 11, 12, 13, 14, 15, and 16. The plurality of peripheral surfaces 11, 12, 13, 14, 15, and 16 are disposed circumferentially. Each of the plurality of peripheral surfaces 11, 12, 13, 14, 15, and 16 extends arcuately. The at least one first pattern a is defined on one of the plurality of peripheral surfaces 11, 12, 13, 14, 15, and 16, i.e., the first peripheral surface 11. Also, the at least one first pattern a is extended therein on the one of the plurality of peripheral surfaces 11, 12, 13, 14, 15, and 16. The at least one first pattern a has a first height. The at least one first pattern a is extended in the first peripheral surface 11. The first pattern a defines a recess. The first pattern a includes two slopes a1. The two slopes a1 are disposed oppositely and extends towards each other. The two slopes a1 include a common edge defining a bottom edge a2 of the first pattern a. The at least one second pattern b is defined on the one of the plurality of peripheral surfaces 11, 12, 13, 14, 15, and 16. The at least one second pattern b has a second height. The second height is different from the first height. The second pattern b is flush with the first peripheral surface 11. Moreover, the ball end 1 includes the second end 112 including an end surface 17. The end surface 17 includes a peripheral edge which delimits first distal ends of the plurality of peripheral surfaces 11, 12, 13, 14, 15, and 16. In the embodiment, the end surface 17 is a planar surface.

The ball end hex wrench further includes an operating end 3, and a neck 4. The neck 4 includes a first distal end connected with the ball end 1 and a second distal end connected with the operating end 3 respectively and extends arcuately from the first distal end to the second distal end.

The ball end hex wrench is capable of driving an object 2 and defines a range of working angles. The object 2 includes a hole 201, an end wall 202, and a lateral wall 203. The hole 201 includes one of two opposite distal ends defining an opening and the other distal end delimited by the end wall 202. Moreover, the hole 201 includes a periphery delimited by the lateral wall 203. Therefore, when the object 2 is being driven by the ball end hex wrench, the ball end hex wrench includes the ball end 1 disposed in the hole 201, the end surface 17 abutted against the end wall 202, and the engaging section S including a region circumferentially abutted against the lateral wall 203, as well as the first pattern a partially contacting with the lateral wall 203. Additionally, the ball end hex wrench includes all the first longitudinal length of first pattern a capable of contacting with the lateral wall 203.

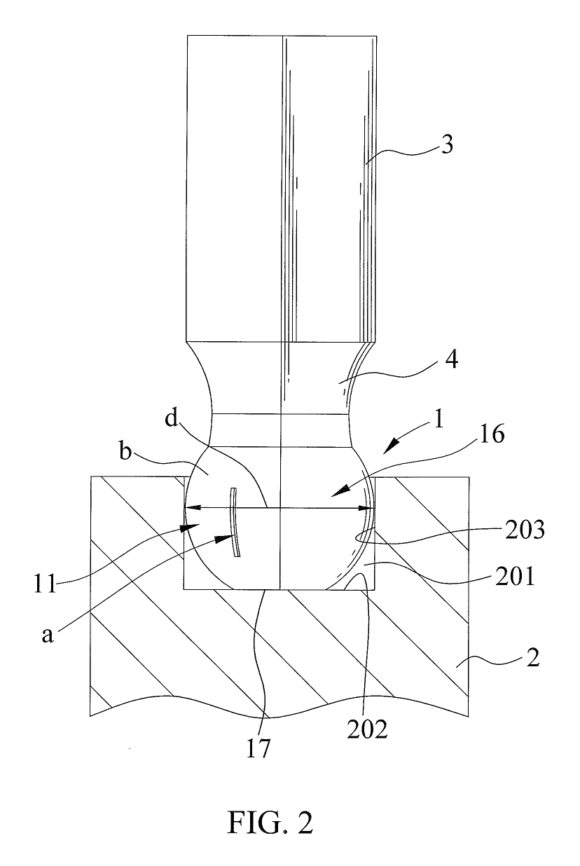

FIG. 2 shows the ball end hex wrench in a position where it is disposed at one of the range of working angles and includes the ball end 1 disposed horizontally and includes the engaging section S including a region with an outer diameter d, which is the maximum outer diameter of the ball end hex wrench, abutted against the lateral wall 203.

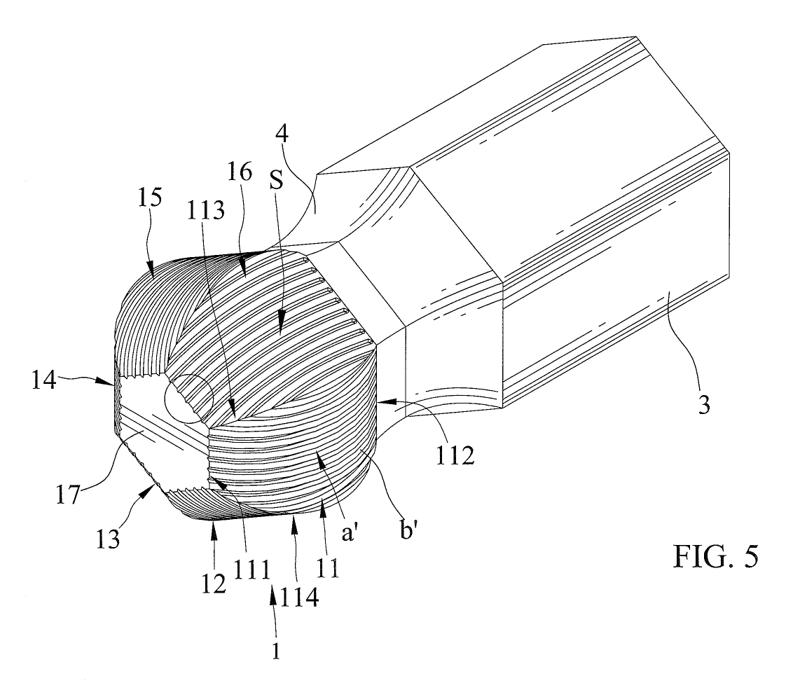

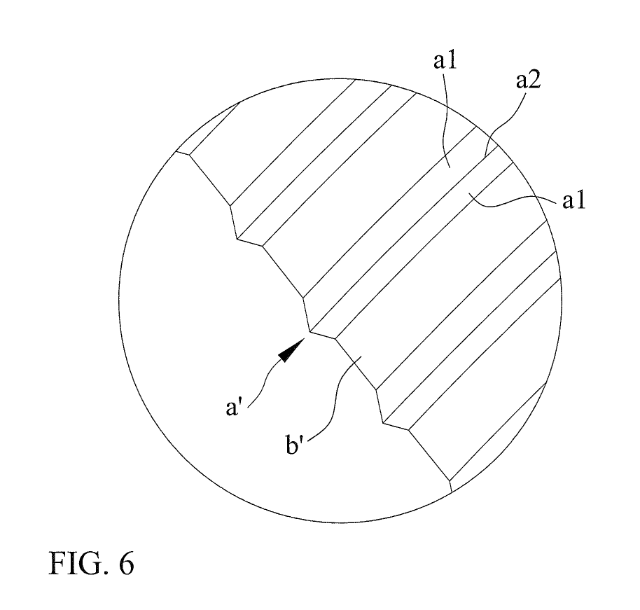

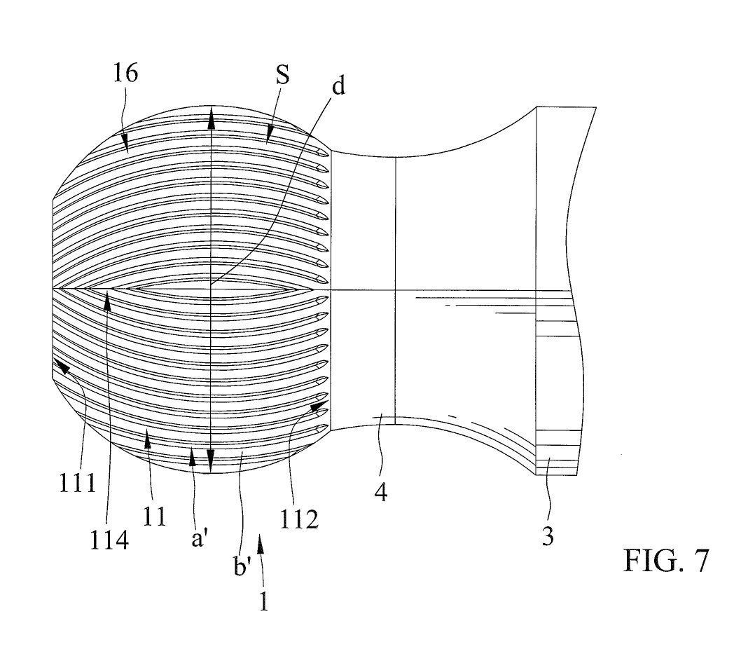

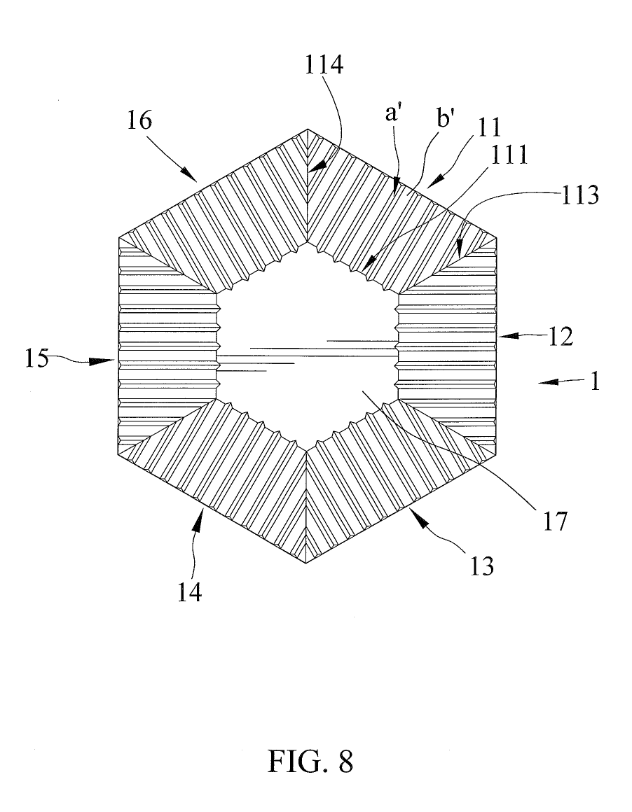

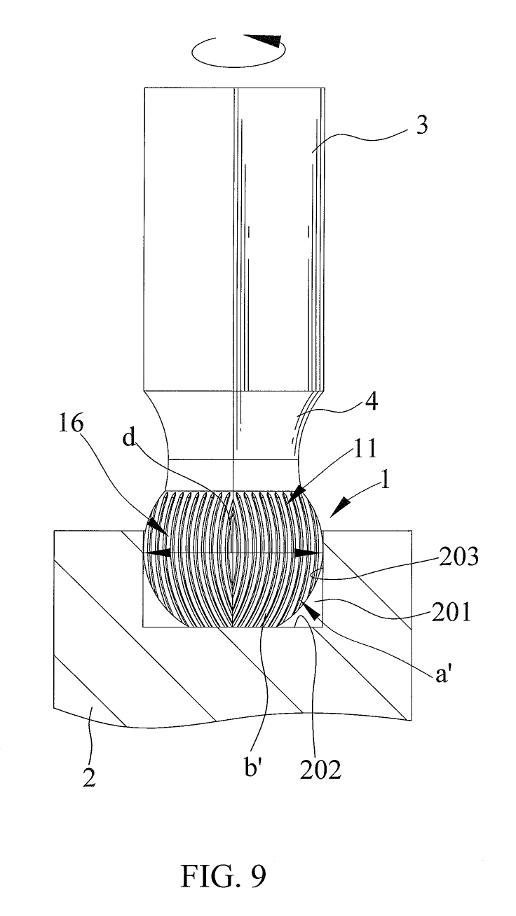

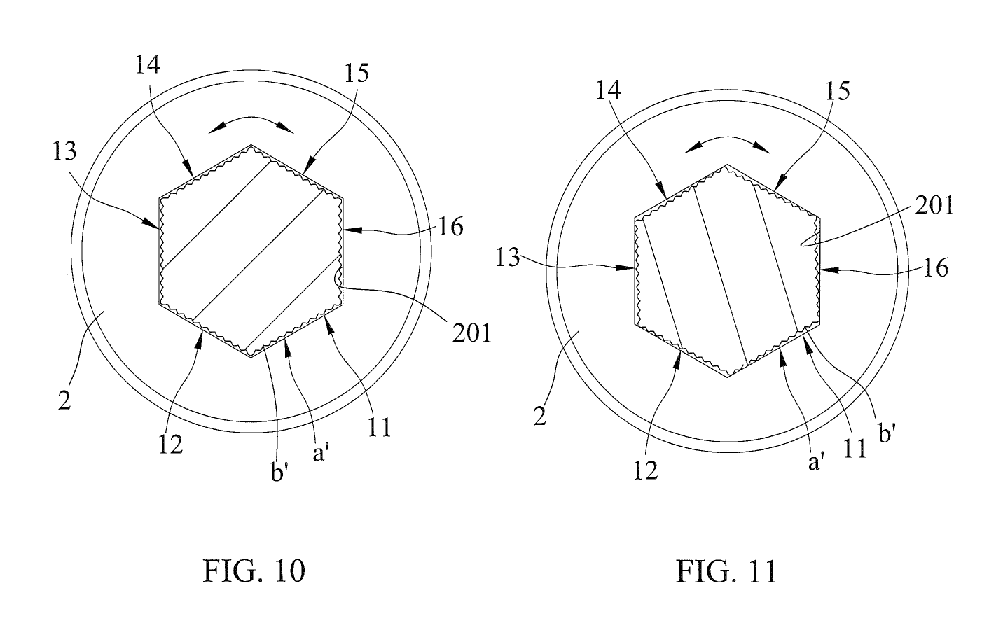

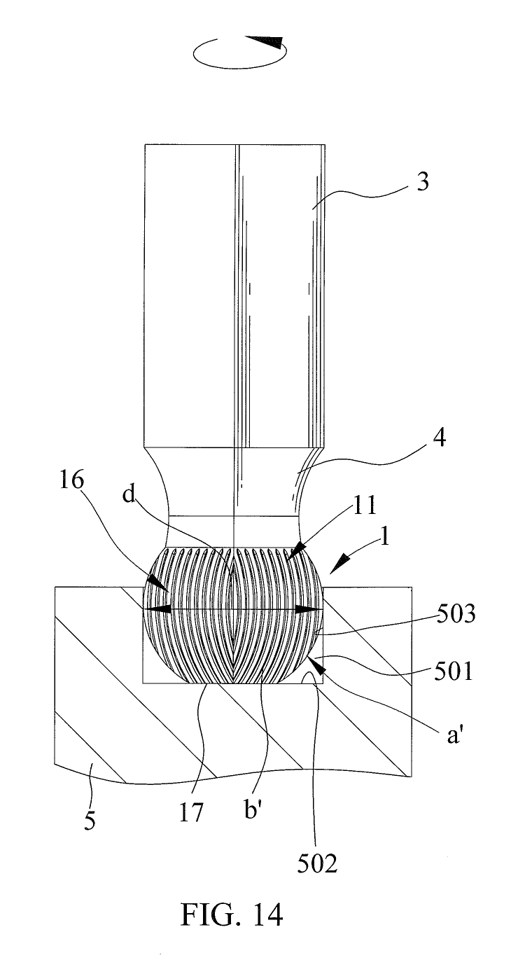

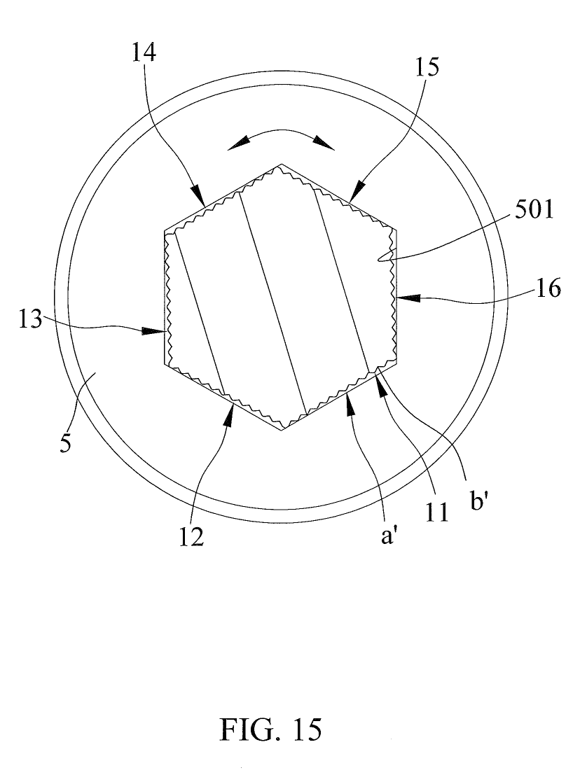

FIGS. 5 through 15 show a ball end hex wrench in accordance with a second embodiment of the present invention. The second embodiment differentiates from the first embodiment in that it includes a plurality of first and second patterns a′ and b′. The plurality of first and second patterns a′ and b′ are defined on the first, second, third, fourth, fifth, and sixth peripheral surfaces 11, 12, 13, 14, 15, and 16. Each of the first, second, third, fourth, fifth, and sixth peripheral surfaces 11, 12, 13, 14, 15, and 16 includes the plurality of first patterns a′ extended outward therefrom and the plurality of second pattern b′ being flush therewith. Each of the plurality of first patterns a′ defining a ridge. The plurality of first and second patterns a′ and b′ are extend in the same direction. Two of the plurality of first patterns a′ and b′ include one of the plurality of second patterns b′ disposed therebetween.

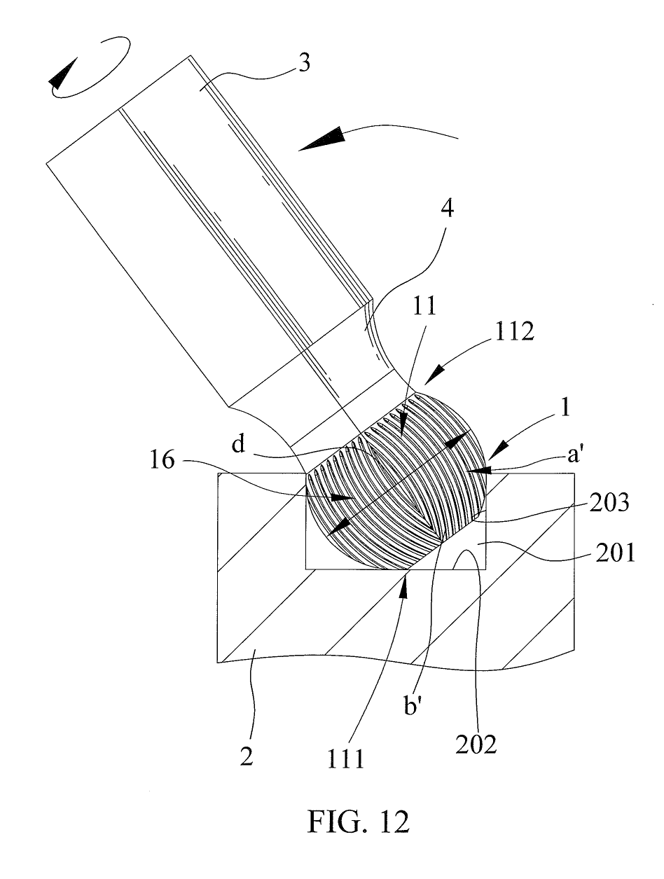

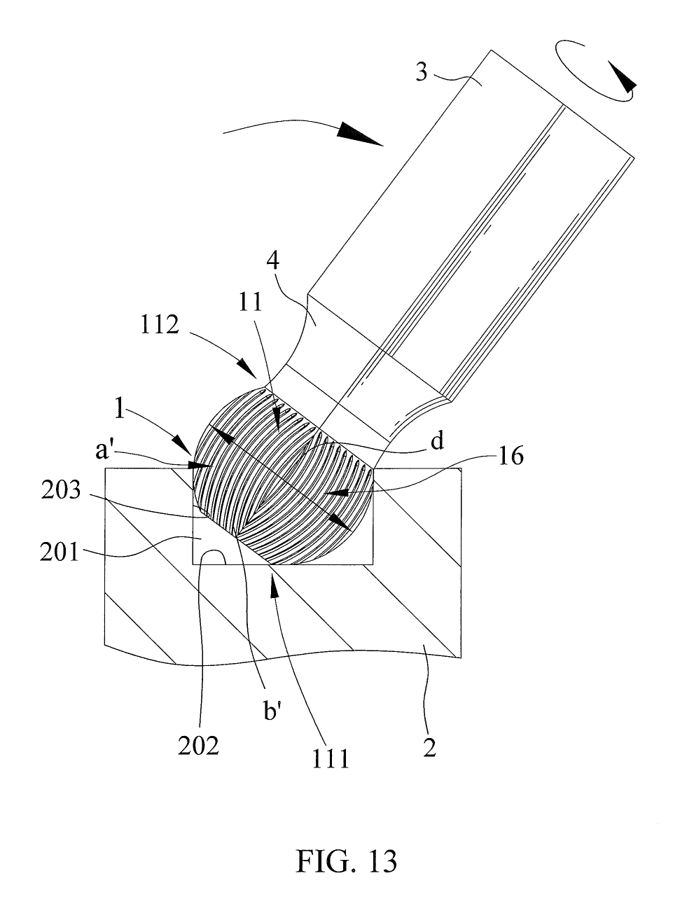

The ball end hex wrench including a first distal end and a second distal end, which is distanced form the first distal end at a longitudinal length. Additionally, FIG. 12 shows the hex wrench not disposed horizontally and including the first pattern a′ including the first distal end abutted against the lateral wall 203 and the second distal end not abutted against the lateral wall 203. Furthermore, FIG. 13 shows the hex wrench not disposed horizontally and including the first pattern a′ including the first distal end not abutted against the lateral wall 203 and the second distal end abutted against the lateral wall 203.

In addition, the ball end hex wrench is capable of being utilized to drive an object 5 which has a hole 501 that does not have a shape of right hexagon. Likewise, the object 5 includes the hole 501 including one of two opposite distal ends defining an opening and the other distal end delimited by the end wall 502. Moreover, the hole 501 includes a periphery delimited by the lateral wall 503.

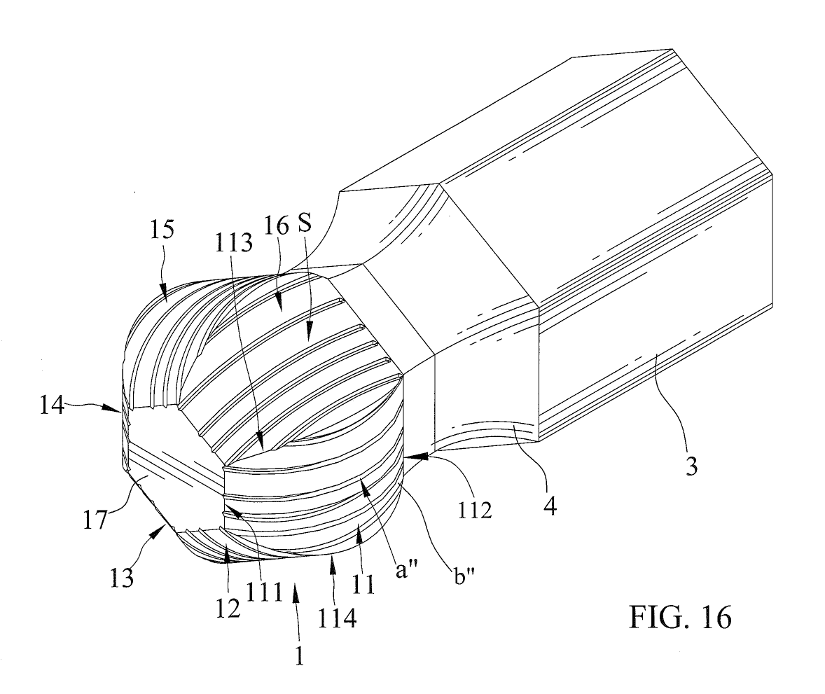

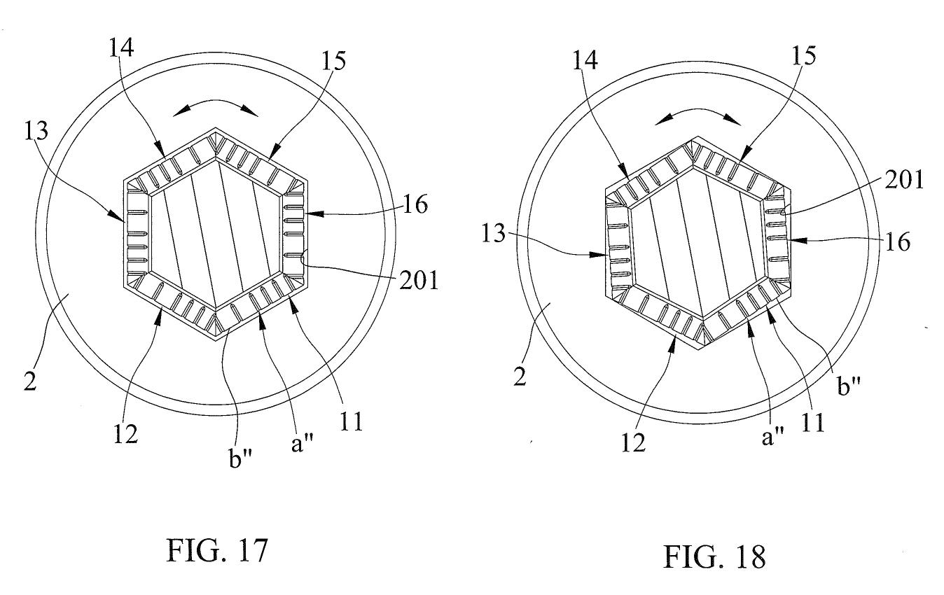

FIGS. 16 through 18 show a ball end hex wrench in accordance with a third embodiment of the present invention. The third embodiment is similar to the second embodiment as it also includes a plurality of first and second patterns a″ and b″, but the number of the plurality of first and second patterns a″ and b″ are less than the number of the plurality of first and second patterns a′ and b′. The plurality of first and second patterns a″ and b″ are defined on the first, second, third, fourth, fifth, and sixth peripheral surfaces 11, 12, 13, 14, 15, and 16. Each of the first, second, third, fourth, fifth, and sixth peripheral surfaces 11, 12, 13, 14, 15, and 16 includes the plurality of first patterns a″ extended outward therefrom and the plurality of second pattern b″ being flush therewith. Each of the plurality of first patterns a″ defining a ridge. The plurality of first and second patterns a″ and b″ are extend in the same direction. Two of the plurality of first patterns a″ and b″ include one of the plurality of second patterns b″ disposed therebetween.

In view of the forgoing, the ball end hex wrench includes the first and second patterns a, a′, and a″; b, b′, and b″ for allowing the ball end to be engaged and disengaged from the objects 2 and 5 more easily and for preventing the ball end from easily damaging the holes 201 and 501 of the objects 2 and 5 and such that operating of the hex wrench to drive the object can become more effortlessly.

While the specific embodiments have been illustrated and described, numerous modifications come to mind without significantly departing from the spirit of invention, and the scope of invention is only limited by the scope of the accompanying claims.

What is claimed is:

1. A ball end hex wrench comprising:
a ball end capable of being used to drive an object including:
an engaging section abutting against the object when the ball end hex wrench drives the object, with the engaging section including a plurality of peripheral surfaces, with the plurality of peripheral surfaces disposed circumferentially, with each of the plurality of peripheral surfaces extending arcuately;
at least one first pattern defined on one of the plurality of peripheral surfaces, with the at least one first pattern having a first height; and
at least one second pattern defined on the one of the plurality of peripheral surfaces, with the at least one second pattern having a second height; with the second height different from the first height;
an operating end;
a neck including a first distal end connected with the ball end and a second distal end connected with the operating end respectively and extending arcuately from the first distal end to the second distal end.

2. The ball end hex wrench as claimed in claim 1, wherein the one of the plurality of peripheral surfaces includes the at least one first pattern extended therein and the second pattern being flush therewith, with the first pattern defining a recess, with the first pattern partially contacting with the object when the ball end hex wrench is driving the object and is disposed at one of various working-angle positions, and wherein the first pattern including a longitudinal length, with all the longitudinal length of first pattern capable of contacting with the object.

3. The ball end hex wrench as claimed in claim 2, wherein the first pattern includes two slopes, with the two slopes disposed oppositely, with the two slopes extending towards each other, with the two slopes including a common edge defining a bottom edge of the first pattern.

4. The ball end hex wrench as claimed in claim 1, the one of the plurality of peripheral surfaces includes a plurality of the first and second patterns, with the plurality of first and second patterns extending in a same direction, with two of the plurality of first patterns including one of the plurality of second patterns disposed therebetween.

5. The ball end hex wrench as claimed in claim 1, wherein each of the plurality of peripheral surfaces includes a plurality of the first and second patterns, with the plurality of first and second patterns extending in a same direction, with two of the plurality of first patterns including one of the plurality of second patterns disposed therebetween.

6. The ball end hex wrench as claimed in claim 4, wherein the one of the plurality of peripheral surfaces includes the plurality of first patterns extended outward therefrom and the plurality of second pattern being flush therewith, with each of the plurality of first patterns defining a ridge.

7. The ball end hex wrench as claimed in claim 5, wherein each of the plurality of peripheral surfaces includes the plurality of first patterns extended outward therefrom and the plurality of second pattern being flush therewith, with each of the plurality of first patterns defining a ridge.

8. The ball end hex wrench as claimed in claim 6, wherein the plurality of first patterns are partially contacted with the object when the ball end hex wrench is driving the object and is disposed at one of various working-angle positions, and wherein each of the plurality of first patterns includes a longitudinal length, with all the longitudinal length of each of first patterns capable of contacting with the object.

9. The ball end hex wrench as claimed in claim 7, wherein the plurality of first patterns are partially contacted with the object when the ball end hex wrench is driving the object and is disposed at one of various working-angle positions, and wherein each of the plurality of first patterns includes a longitudinal length, with all the longitudinal length of each of first patterns capable of contacting with the object.
